(19) United States
(12) Patent Application Publication
(10) Pub. No.: US 2021/0150342 A1
(43) Pub. Date: May 20, 2021

(54) METHOD AND DEVICE FOR PROCESSING DATA OF A TECHNICAL SYSTEM

(71) Applicant: Robert Bosch GmbH, Stuttgart (DE)

(72) Inventors: Benjamin Hettwer, Stuttgart (DE); Sebastien Leger, Stuttgart (DE)

(21) Appl. No.: 16/990,315

(22) Filed: Aug. 11, 2020

(30) Foreign Application Priority Data
Nov. 19, 2019 (DE) 102019217811.1

(51) Int. Cl. G06N 3/08; G06N 3/063; G06N 3/04; G06K 9/62; H04L 9/08

(52) U.S. Cl. CPC G06N 3/08; G06N 3/063; H04L 9/0819; G06K 9/6256; G06N 3/0454

(57) ABSTRACT

A computer-implemented method for processing data of a technical system having multiple data processing areas, which is designed for processing input data, in particular of a computing device for carrying out cryptographic methods, based on the input data. The computer-implemented method including a) modeling at least one part of the technical system with the aid of at least one, in particular artificial, neural network; b) ascertaining at least two physical variables of the technical system for at least two of the multiple data processing areas, in particular during a processing of at least one part of the input data, the at least two physical variables each being assigned to one different data processing area, the at least two physical variables being at least temporarily assigned to the neural network as input variables.

### CROSS REFERENCE

The present application claims the benefit under 35 U.S.C. § 119 of German Patent Application No. DE 102019217811.1 filed on Nov. 19, 2019, which is expressly incorporated herein by reference in its entirety.

### FIELD

The present invention relates to a method for processing data of a technical system.

The present invention further relates to a device for processing data of a technical system.

### SUMMARY

Preferred specific embodiments of the present invention relate to a method, in particular a computer-implemented method, for processing data of a technical system having multiple data processing areas, which is designed for processing input data, in particular of a computing device for carrying out cryptographic methods based on the input data, including, a) modeling at least one part of the technical system with the aid of at least one, in particular artificial, neural network; b) ascertaining at least two physical variables of the technical system for at least two of the multiple data processing areas, in particular during a processing of at least one part of the input data, the at least two physical variables each being assigned to one different data processing area, the at least two physical variables being at least temporarily supplied to the neural network as input variables. This advantageously makes it possible to jointly process the at least two physical variables with the aid of the neural network, whereby, for example side channel information of the different data processing areas of the technical system may be combined with the aid of the neural network. In further preferred specific embodiments, efficient side channel attacks on such technical systems, for example, may be implemented thereby, which distribute, for example, a processing of data to their multiple data processing areas, in particular using cryptographic methods for concealment or masking purposes.

The term side channel attacks describes a class of techniques, with the aid of which, for example, confidential parameters, e.g., of a cryptographic implementation, implemented by a technical system, may be extracted (e.g., key material of encryption methods).

To make side channel attacks more difficult, it is conventional to incorporate certain countermeasures into cryptographic implementations. One main category thereof is the so-called masking. Masking is based on the idea of randomizing (“masking”) sensitive intermediate results which occur, for example, during the calculation of a cryptographic operation (e.g., encrypting a plain text with the aid of a secret key), in particular to interrupt a data dependency, e.g., of the power consumption of the technical system or the implementation of the secret key. In an additive masking scheme of order d, e.g., every sensitive intermediate value x of an algorithm is represented and processed in d+1 number of shares, for example the first d number of shares is randomly selected, and the last share is calculated according to a certain specification. If the specified shares are processed or calculated, for example with the aid of different data processing areas of the technical system, conventional side channel attacks are made significantly more difficult.

Example methods according to the preferred specific embodiments of the present invention, however, permit efficient side channel attacks even in approaches of this type, because the neural network according to preferred specific embodiments may combine information, in particular side channel leakage, of the different data processing areas and thus the different shares. In this way, it is possible to successfully ascertain, for example, an interesting intermediate value x of the algorithm without the actual mask values of the masking method having to be known or ascertained.

In further preferred specific example embodiments of the present invention, it is provided that the modeling includes at least one of the following elements: a) providing the neural network, the neural network being designed, in particular, as a deep neural network (including an input layer, an output layer and at least one intermediate layer (“hidden layer”) situated between the input layer and the output layer), the neural network being, in particular, already trained; b) training the neural network using the at least two physical variables and further input variables, in particular the further input variables including at least one of the following elements: A) known input data for the technical system; B) a cryptographic key.

In further preferred specific embodiments of the present invention, it is provided that the method also includes: training the neural network using known or the known input data, in particular in a first operating phase; processing data of the technical system and/or a further technical system, in particular in a second operating phase following the first operating phase.

In further preferred specific embodiments of the present invention, it is provided that the neural network is an artificial neural network of the CNN type (convolutional neural network, i.e., a neural network based on convolutional operations) and/or the RNN type (recurrent neural network) and/or the MLP type (multilayer perceptron) and/or a mixed form thereof.

In further preferred specific embodiments of the present invention, it is provided that the ascertainment of the at least two physical variables of the technical system includes at least one of the following elements: a) ascertaining a time characteristic of an electric field of the at least one data processing area; b) ascertaining a time characteristic of a magnetic field of the at least one data processing area; c) ascertaining a time characteristic of an electromagnetic field of the at least one data processing area; d) ascertaining a time characteristic of a voltage assigned to the at least one data processing area (or a variable characterizing the voltage), in particular the voltage being ascertained at at least one decoupling capacitor, which is assigned, in particular, to the at least one data processing area.

Further preferred specific embodiments of the present invention relate to a method, in particular a computer-implemented method, for training an, in particular artificial, neural network, which is designed to model at least one part of a technical system including multiple data processing areas, the technical system being designed to process input data, in particular the technical system including or being a computing device for carrying out cryptographic methods based on the input data, the method including: operating the technical system with the aid of known input data; ascertaining at least two physical variables of the technical system, in particular during the operation of the technical system, with the aid of the known input data, the at least two physical variables each being assigned to a different data processing area of the multiple data processing areas; training the neural network as a function of at least the known input data and/or the at least two physical variables.

In further preferred specific embodiments of the present invention, it is provided that the ascertainment of the at least two physical variables of the technical system includes at least one of the following elements: a) ascertaining a time characteristic of an electrical field of the at least one data processing area; b) ascertaining a time characteristic of a magnetic field of the at least one data processing area; c) ascertaining a time characteristic of an electromagnetic field of the at least one data processing area; d) ascertaining a time characteristic of a voltage assigned to the at least one data processing area, in particular the voltage being ascertained at at least one decoupling capacitor, which is assigned, in particular, to the at least one data processing area.

Further preferred specific embodiments of the present invention relate to a device for carrying out the method according to the specific embodiments.

In further specific embodiments of the present invention, it is provided that the device includes: a computing device (“computer”), a memory device assigned to the computing device for at least temporarily storing at least one of the following elements: a) data; b) computer program, in particular for carrying out the method according to the specific embodiments.

In further preferred specific embodiments of the present invention, the data may at least temporarily include information, in particular parameters (e.g., weights, bias values, parameters of activation functions, etc.) of the neural network.

Further preferred specific embodiments of the present invention relate to a computer-readable storage medium, including commands, which, when executed by a computer, prompt the latter to carry out the method according to the specific embodiments.

Further preferred specific embodiments of the present invention relate to a computer program, including commands, which, when the program is executed by a computer, prompt the latter to carry out the method according to the specific embodiments.

Further preferred specific embodiments of the present invention relate to a data carrier signal, which characterizes and/or transfers the computer program according to the specific embodiments.

Further preferred specific embodiments of the present invention relate to a use of the method according to the specific embodiments and/or the device according to the specific embodiments and/or the computer program according to the specific embodiments and/or the data carrier signal according to the specific embodiments for at least one of the following elements: a) carrying out at least one attack, in particular a side channel attack, on the technical system; b) combining side channel information of the technical system assigned to different processing areas; c) training the neural network; d) training the neural network to combine side channel information of the technical system assigned to different processing areas.

Additional features, possible applications and advantages of the present invention are derived from the following description of exemplary embodiments of the present invention, which are illustrated in the figures. All features described or illustrated form the subject matter of the present invention alone or in any arbitrary combination, regardless of their wording in the description or illustration in the figures.

### BRIEF DESCRIPTION OF THE DRAWINGS

FIG. 1 schematically shows a simplified block diagram of a technical system according to preferred specific embodiments of the present invention.

FIG. 2 schematically shows a first operating phase according to further preferred specific embodiments of the present invention.

FIG. 3 schematically shows a second operating phase according to further specific embodiments of the present invention.

FIG. 4A schematically shows a simplified flowchart of a method according to further preferred specific embodiments of the present invention.

FIG. 4B schematically shows a simplified flowchart of a method according to further preferred specific embodiments of the present invention.

FIG. 4C schematically shows a simplified flowchart of a method according to further preferred specific embodiments of the present invention.

FIG. 5A schematically shows a simplified flowchart of a method according to further preferred specific embodiments of the present invention.

FIG. 5B schematically shows a simplified flowchart of a method according to further preferred specific embodiments of the present invention.

FIG. 6 schematically shows a simplified block diagram of a device according to further preferred specific embodiments of the present invention.

FIG. 7 schematically shows a simplified flowchart of a method according to further preferred specific embodiments of the present invention.

### DETAILED DESCRIPTION OF EXAMPLE EMBODIMENTS

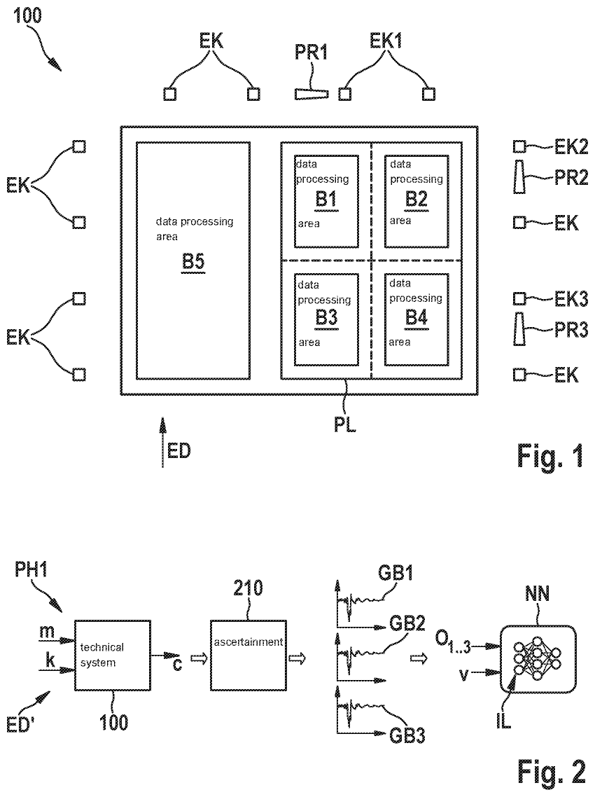

FIG. 1 schematically shows a simplified block diagram of a technical system 100 according to preferred specific embodiments. System 100 is designed to process input data ED, for example for carrying out cryptographic methods, based on input data ED. System 100 preferably has multiple data processing areas B1, B2, B3, B4, B5, each of which is designed to process data, in particular input data ED and/or data derivable therefrom.

In other preferred specific embodiments, system 100 may be designed, for example, as a system on chip (SoC) 100, including a computing unit or a processor (“processing system”) B5 and, for example, a programmable logic unit PL, for example an FPGA (field-programmable gate array), logic unit PL implementing data processing areas B1, B2, B3, B4. For example, SoC 100 is designed to execute cryptographic algorithms, for example steps of the AES method, masking techniques being applicable, which assign different shares to each data processing area B1, B2, B3 for carrying out the corresponding calculations, e.g., for the purpose of making conventional side channel attacks more difficult.

For details on AES (advanced encryption standard), cf. for example https://doi.org/10.6028/NIST.FIPS.197. In further preferred specific embodiments, the cryptographic method may also include a method other than the encryption method mentioned as an example, e.g., a hash value formation or the like.

In further preferred specific embodiments of the present invention, data processing areas B1, B2, B3 may be assigned or correspond to, in particular different clock regions (CR) of FPGA PL, for example to avoid coupling effects therebetween, which would reduce the security of the implementation of the cryptographic algorithms in SoC 100.

In further preferred specific embodiments of the present invention, multiple decoupling capacitors EK, which are designated collectively in FIG. 1 by reference sign EK and which form, for example, a part of an electrical power supply of SoC 100, are assigned to SoC 100. In further preferred specific embodiments, additional decoupling capacitors EK1, EK2, EK3 may also be provided, which are each assigned, for example, to a specific one of multiple data processing areas B1, B2, B3. For example, decoupling capacitor EK1 is assigned to data processing area B1, decoupling capacitor EK2 is assigned to data processing area B2 and decoupling capacitor EK3 is assigned to data processing area B3.

In further specific embodiments of the present invention, SoC 100 includes multiple voltage (supply) lines, which each supply, in particular, a different part of SoC 100 with current. In particular, FPGA PL may be divided into multiple of clock regions (“CR”) already mentioned above, the individual CRs being suppliable with current via different pins of a power supply of FPGA PL.

The features according to preferred specific embodiments of the present invention described below as an example with reference to FIGS. 2 through 10 advantageously makes it possible to collect side channel information, for example with respect to individual shares of masking techniques against side channel attacks in SoC 100 according to FIG. 1 or a comparable technical system 100 or generally in a system 100 having multiple data processing areas B1, B2, B3, . . . , on which basis, for example side channel attacks against system 100 or a comparable system 100 (e.g., with an identical or similar implementation) may be efficiently carried out according to further preferred specific embodiments.

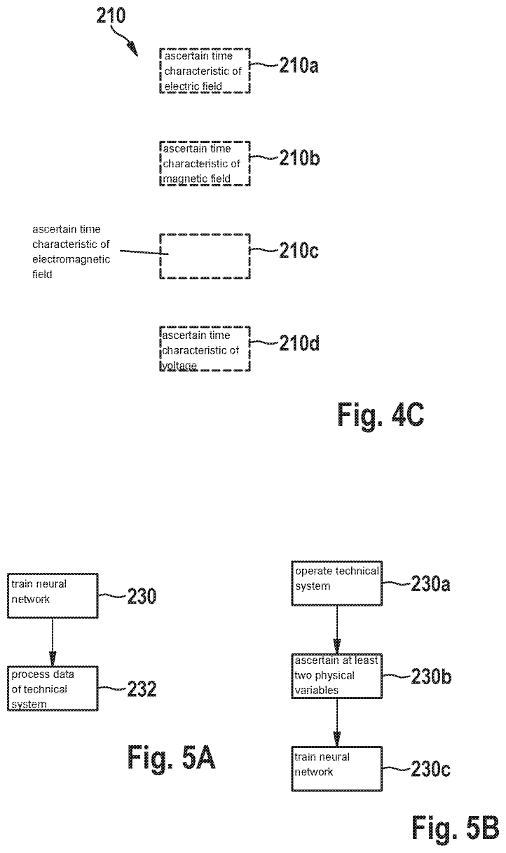

Further preferred specific embodiments of the present invention relate to a method, in particular a computer-implemented method, for processing data of a or the technical system 100 (FIG. 1), including the following steps, cf. FIG. 4A: a) modeling 200 at least one part of technical system 100 with the aid of at least one, in particular artificial, neural network NN (FIG. 2); b) ascertaining 210 (FIG. 4A) at least two physical variables GB1, GB2, GB3 of technical system 100 for at least two of multiple data processing areas B1, B2, B3, in particular during a processing of at least one part of input data ED by technical system 100, the at least two physical variables GB1, GB2, GB3 each being assigned to a different data processing area B1, B2, B3, the at least two physical variables GB1, GB2, GB3 being at least temporarily supplied to neural network NN as input variables, cf. step 220 from FIG. 4A. This advantageously makes it possible to jointly process the at least two physical variables GB1, GB2, GB3 with the aid of neural network NN, whereby, for example side channel information of the different data processing areas B1, B2, B3 of technical system 100 may be combined with the aid of neural network NN. In further preferred specific embodiments, efficient side channel attacks on such technical systems 100, for example, may be implemented thereby, which distribute, for example, a processing of data ED to their multiple data processing areas B1, B2, B3, in particular using cryptographic methods for concealment or masking purposes.

Side channel attacks describe a class of techniques, with the aid of which, for example, confidential parameters, e.g., of a cryptographic implementation, implemented by a technical system 100, may be extracted (e.g., key material of encryption methods).

To make side channel attacks more difficult, it is conventional to incorporate certain countermeasures into cryptographic implementations. One main category thereof is the so-called masking. Masking is based on the idea of randomizing (“masking”) sensitive intermediate results which occur, for example, during the calculation of a cryptographic operation (e.g., encrypting a plain text with the aid of a secret key), in particular to interrupt a data dependency, e.g., of the power consumption of the technical system or the implementation of the secret key. In an additive masking scheme of order d, e.g., every sensitive intermediate value x of an algorithm is represented and processed in d+1 number of shares, for example the first d number of shares is randomly selected, and the last share is calculated according to a certain specification. If the specified shares are processed or calculated, for example with the aid of different data processing areas of the technical system, conventional side channel attacks are made significantly more difficult.

The method according to preferred specific embodiments of the present invention, however, permits efficient side channel attacks even in approaches of this type, because neural network NN according to preferred specific embodiments may combine information, in particular side channel leakage, of the different data processing areas B1, B2, B3 and thus the different shares. In this way, it is possible to successfully ascertain, for example, an interesting intermediate value x of the algorithm without the actual mask values of the masking method having to be known or ascertained.

In further preferred specific embodiments of the present invention, it is provided that modeling 200 includes at least one of the following elements, cf. FIG. 4B: a) providing 200a neural network NN, neural network NN being designed, in particular, as a deep neural network (including an input layer, an output layer and at least one intermediate layer (“hidden layer”) situated between the input layer and the output layer), neural network NN being, in particular, already trained; b) training 200b (FIG. 4B) the neural network, using the at least two physical variables GB1, GB2, GB3 and further input variables EG, in particular the further input variables including at least one of the following elements: A) known input data ED for the technical system;

B) a cryptographic key.

In further preferred specific embodiments of the present invention, it is provided that the method also includes, cf. FIG. 5A: training 230 neural network NN, using known or the known input data ED, in particular in a first operating phase PH1 (FIG. 2); processing 232 (FIG. 5A) data of technical system 100 and/or a further technical system 100′, in particular in a second operating phase PH2 following first operating phase PH1.

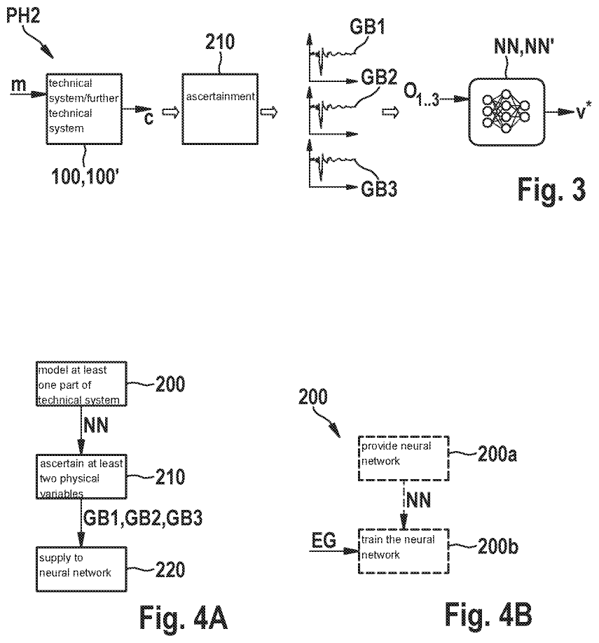

This is illustrated as an example in FIGS. 2, 3, FIG. 2 showing first operating phase PH1 according to further preferred specific embodiments. Known input data ED′ is supplied to system 100 and processed by system 100. For example, system 100 may include an implementation of an AES encryption method, known input data ED′ including a plain text m to be encrypted and a key k (known for training purposes of neural network NN and otherwise generally secret).

In further preferred specific embodiments of the present invention, it is provided that neural network NN is an artificial neural network of the CNN type (convolutional neural network, i.e., a neural network based on convolutional operations) and/or the RNN type (recurrent neural network) and/or the MLP type (multilayer perceptron) and/or a mixed form thereof.

Block 210 in FIG. 2 symbolizes the ascertainment, already described above with reference to FIG. 4A, of at least two physical variables GB1, GB2, GB3 of technical system 100, in particular during the processing of at least one part of input data ED′ (which is known in this case) by technical system 100. Letter c in FIG. 2 represents the output data of system 100, for example the AES-encrypted plain text.

In further preferred specific embodiments of the present invention, it is provided that ascertainment 210 of the at least two physical variables GB1, GB2, GB3 of technical system 100 includes at least one of the following elements, also cf. FIG. 4C: a) ascertaining 210a a time characteristic of an electric field of the at least one data processing area; b) ascertaining 210b a time characteristic of a magnetic field of the at least one data processing area; c) ascertaining 210c a time characteristic of an electromagnetic field of the at least one data processing area; d) ascertaining 210d a time characteristic of a voltage assigned to the at least one data processing area, in particular the voltage being ascertained at at least one decoupling capacitor, which is assigned, in particular, to the at least one data processing area.

In the present case, the voltage or a time characteristic of the voltage is preferably ascertained, which is present at individual decoupling capacitors EK1, EK2, EK3, which, as described above, are each assigned, in particular to precisely one of data processing areas B1, B2, B3. For example, physical variable GB1 thus corresponds to the time characteristic of the voltage at decoupling capacitor EK1, which is assigned to data processing area B1, physical variable GB2 corresponds to the time characteristic of the voltage at decoupling capacitor EK2, and physical variable GB3 corresponds to the time characteristic of the voltage at decoupling capacitor EK3.

In further preferred specific embodiments of the present invention, neural network NN is trained in first operating phase PH1 according to FIG. 2, using physical variables GB1, GB2, GB3 and known input data ED′. This is symbolized in FIG. 2 in that first variables O_{1 . . . 3}, corresponding to physical variables GB1, GB2, GB3, and at least one second variable v, are supplied to neural network NN as input variables for training purposes.

Second variable v preferably corresponds, for example to a result or an intermediate result of the cryptographic method, as carried out by technical system 100, based on input data ED′ (known in the present case).

In further preferred specific embodiments of the present invention, during the training, weights and/or other parameters of neural network NN are changed, in particular according to known training methods, to achieve the desired behavior of the neural network, for example approximation v* (FIG. 3) of second variable v (FIG. 2) as a function, in particular solely, of physical variables GB1, GB2, GB3 or O_{1 . . . 3}.

Once neural network NN has been trained, for example as described above, e.g., a side channel attack on system 100 or a further system 100′ (which includes, e.g., a same or similar implementation of the cryptographic method as system 100 according to FIG. 2) may be carried out in second operating phase PH2 (FIG. 3). For this purpose, plain text m is supplied to system 100, 100′ (FIG. 3), and in turn physical variables GB1, GB2, GB3 are ascertained (Block 210 from FIG. 3) and supplied to trained neural network NN′, which outputs approximation v* for second variable v based thereon.

Further preferred specific embodiments relate to a method, in particular a computer-implemented method, for training an, in particular artificial, neural network NN, which is designed to model at least one part of a technical system 100 including multiple data processing areas B1, B2, B3, technical system 100 being designed to process input data ED, in particular technical system 100 including or being a computing device for carrying out cryptographic methods, based on the input data. According to further preferred specific embodiments, the training method may form, for example, a supplement to the methods described above with reference to FIGS. 1, 2, 3, 4A, 4B, 4C.

In further preferred specific embodiments of the present invention, it is provided that the training method is carried out as an independent method, e.g., according to FIG. 5A, in particular without at least some steps according to FIG. 4A.

In further preferred specific embodiments of the present invention, the training method includes, cf. FIG. 5B: operating 230a technical system 100 (FIG. 2) with the aid of known input data ED′; ascertaining 230b at least two physical variables GB1, GB2, GB3 (e.g., with the aid of Block 210 from FIG. 2) of the technical system 100, in particular during the operation of technical system 100, with the aid of known input data ED′, the at least two physical variables GB1, GB2, GB3 each being assigned to a different data processing area B1, B2, B3 of the multiple data processing areas; training 230c (FIG. 5B) neural network NN as a function of at least the known input data ED′ and/or the at least two physical variables GB1, GB2, GB3.

In further preferred specific embodiments of the present invention, it is provided that ascertainment 230b (FIG. 5B) of the at least two physical variables of the technical system includes at least one of the following elements: a) ascertaining a time characteristic of an electric field of the at least one data processing area; b) ascertaining a time characteristic of a magnetic field of the at least one data processing area; c) ascertaining a time characteristic of an electromagnetic field of the at least one data processing area; d) ascertaining a time characteristic of a voltage assigned to the at least one data processing area, in particular the voltage being ascertained at at least one decoupling capacitor, which is assigned, in particular, to the at least one data processing area.

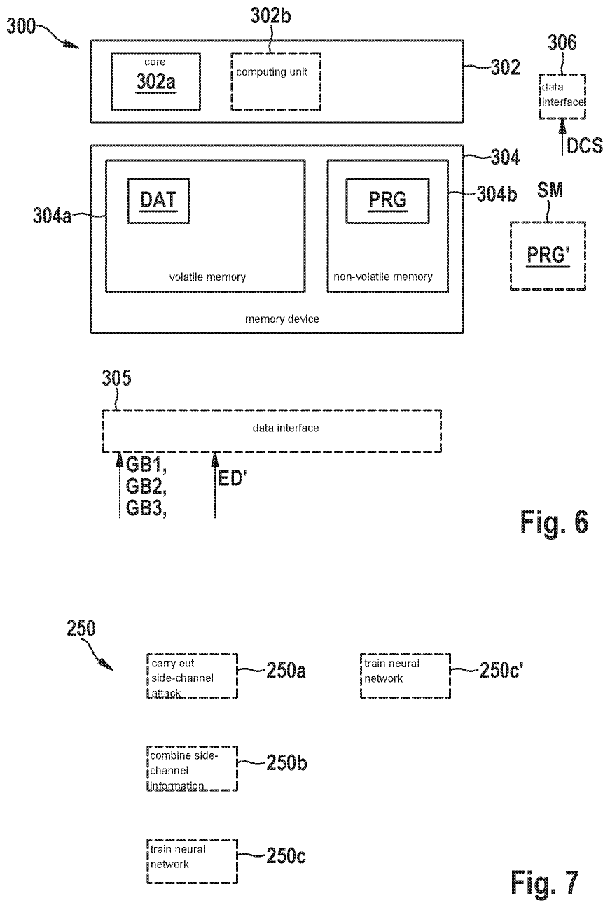

Further preferred specific embodiments of the present invention relate to a device 300, cf. FIG. 6, for carrying out the method according to the specific embodiments of the present invention.

In further specific embodiments of the present invention, it is provided that device 300 includes: a computing device 302 (“computer”) including at least one core 302a; a memory device 304 assigned to computing device 302 for at least temporarily storing at least one of the following elements: a) data DAT; b) computer program PRG, in particular for carrying out the method according to the specific embodiments.

In further preferred specific embodiments of the present invention, data DAT may at least temporarily include information, in particular parameters (e.g., weights, bias values, parameters of activation functions, etc.) of neural network NN, NN′. In further preferred specific embodiments, data DAT may at least temporarily include physical variables GB1, GB2, . . . and/or data derivable therefrom.

In further preferred specific embodiments of the present invention, memory device 304 includes a volatile memory 304a (e.g., random-access memory (RAM)) and/or a non-volatile memory 304b (e.g., flash EEPROM).

Further preferred specific embodiments of the present invention relate to a computer-readable storage medium SM, including commands PRG′, which, when executed by a computer, prompt the latter to carry out the method according to the specific embodiments of the present invention.

Further preferred specific embodiments of the present invention relate to a computer program PRG, PRG′, including commands, which, when program PRG, PRG′ is executed by a computer 302, prompt the latter to carry out the method according to the specific embodiments of the present invention.

Further preferred specific embodiments of the present invention relate to a data carrier signal DCS, which characterizes and/or transfers computer program PRG, PRG′ according to the specific embodiments. Data carrier signal DCS is receivable, for example, via an optional data interface 306 of device 300.

In further preferred specific embodiments of the present invention, computing device 302 may also include at least one computing unit 302b optimized, for example, for an evaluation or design of (trained) neural network NN, NN′ or for a training of a neural network NN, for example a graphics processor (GPU) and/or a tensor processor or the like.

In further preferred specific embodiments of the present invention, device 300 may also include a data interface 305 for receiving physical variables GB1, GB2, GB3 and/or input data ED or known input data ED′ (also cf. FIG. 2).

Further preferred specific embodiments of the present invention relate to a use 250 (FIG. 7) of the method according to the specific embodiments and/or device 300 according to the specific embodiments and/or computer program PRG, PRG′ according to the specific embodiments and/or data carrier signal DCS according to the specific embodiments for at least one of the following elements: a) carrying out 250a at least one attack, in particular a side channel attack, on (further) technical system 100, 100′; b) combining 250b side channel information GB1, GB2, GB3 of (further) technical system 100, 100′ assigned to different processing areas B1, B2, B3; c) training 250c (230 FIGS. 5A, 5B) neural network NN; d) training 250c′ neural network NN to combine side channel information GB1, GB2, GB3 of (further) technical system 100, 100′ assigned to different processing areas B1, B2, B3.

In further preferred specific embodiments of the present invention, a method may be carried out, based on the following equation:

$$k = {argmax}_{{k}^{*} ∈ 𝒦} {\prod }_{i = 1}^{{N}_{A}} P [ {O}_{i} \vert g ( {k}^{*} , {p}_{i} ) ]$$

k corresponding to the (secret) key, k* corresponding to a key hypothesis, g( ) corresponding to a target operation, Oᵢ corresponding to the physical variables or side channel information GB1, GB2, GB3, N_{A} corresponding to a number of measurements of the physical variables for a side channel attack.

In further preferred specific embodiments of the present invention, neural network NN may also be referred to as a “multi-input” DNN, i.e., as a deep neural network having multiple input variables, since the at least two physical variables GB1, GB2, GB3 are at least temporarily supplied thereto as input variables according to further preferred specific embodiments.

In further preferred specific embodiments of the present invention, input layer IL (FIG. 2) may include at least a plurality of groups of processing elements (also referred to as “artificial” neurons), for example, a group of processing elements being assigned to each of physical variables GB1, GB2, GB3. In further preferred specific embodiments, physical variable GB1 may be provided, for example, as a data series having M number of voltage measured values of the relevant capacitor voltage of capacitor EK1 (FIG. 1). Input layer IL may then preferably include a first group of M number of processing elements, a voltage measured value being suppliable to each of the M number of processing elements as an input variable. In further preferred specific embodiments of the present invention, this applies similarly to further physical variables GB2, GB3 or groups of input layer IL.

What is claimed is:

1. A computer-implemented method for processing data of a technical system having multiple data processing areas, which is configured for processing input data, the technical system being a computing device configured to carry out cryptographic methods, based on the input data, the method comprising the following steps:
a) modeling at least one part of the technical system using at least one artificial neural network;
b) ascertaining at least two physical variables of the technical system for at least two of the multiple data processing areas during a processing of at least one part of the input data, the at least two physical variables each being assigned to a different data processing area of the multiple data processing areas, the at least two physical variables being at least temporarily supplied to the neural network as input variables.

2. The method as recited in claim 1, wherein the modeling includes at least one of the following steps: a) providing the neural network, the neural network a deep neural network, and the neural network being already trained; b) training the neural network using the at least two physical variables and further input variables, the further input variables including at least one of the following elements: A) known input data for the technical system; B) a cryptographic key.

3. The method as recited in claim 1, further comprising the following steps:
training the neural network using known input data in a first operating phase; and
processing data of the technical system and/or a further technical system in a second operating phase following the first operating phase.

4. The method as recited in claim 1, wherein the neural network is an artificial neural network of a CNN type and/or an RNN type and/or an MLP type and/or a mixed form of the CNN type, the RNN type, and the MLP type.

5. The method as recited in claim 1, wherein the ascertainment of the at least two physical variables of the technical system includes at least one of the following steps:
a) ascertaining a time characteristic of an electric field of the different data processing areas;
b) ascertaining a time characteristic of a magnetic field of the different data processing areas;
c) ascertaining a time characteristic of an electromagnetic field of the different data processing areas;
d) ascertaining a time characteristic of a voltage assigned to the at least one of the different data processing areas, the voltage being ascertained at at least one decoupling capacitor which is assigned to the different data processing areas.

6. A method for training a artificial neural network, which is configured to model at least one part of a technical system including multiple data processing areas, the technical system being configured to process input data, the technical system including a computing device for carrying out cryptographic methods, based on the input data, the method comprising the following steps:
operating the technical system using known input data;
ascertaining at least two physical variables of the technical system during operation of the technical system, using the known input data, the at least two physical variables each being assigned to a different data processing area of the multiple data processing areas; and
training the neural network as a function of at least the known input data and/or the at least two physical variables.

7. The method as recited in claim 6, wherein the ascertainment of the at least two physical variables of the technical system includes at least one of the following steps:
a) ascertaining a time characteristic of an electric field of the different data processing areas;
b) ascertaining a time characteristic of a magnetic field of the different data processing areas;
c) ascertaining a time characteristic of an electromagnetic field of the different data processing areas;
d) ascertaining a time characteristic of a voltage assigned to the different data processing areas, the voltage being ascertained at at least one decoupling capacitor which is assigned to the different data processing areas.

8. A device for processing data of a technical system having multiple data processing areas, the technical system being configured for processing input data, the technical system being a computing device configured to carry out cryptographic methods, based on the input data, the device being configured to:
a) model at least one part of the technical system using at least one artificial neural network;
b) ascertain at least two physical variables of the technical system for at least two of the multiple data processing areas during a processing of at least one part of the input data, the at least two physical variables each being assigned to a different data processing area of the multiple data processing areas, the at least two physical variables being at least temporarily supplied to the neural network as input variables.

9. The device as recited in claim 8, wherein the device includes:
a computing device;
a memory device assigned to the computing device for at least temporarily storing at least one of the following elements: a) data; b) a computer program.

10. A non-transitory computer-readable storage medium on which is stored commands for processing data of a technical system having multiple data processing areas, which is configured for processing input data, the technical system being a computing device configured to carry out cryptographic methods, based on the input data, the commands, when executed by a computer, causing the computer to perform the following steps:
a) modeling at least one part of the technical system using at least one artificial neural network;
b) ascertaining at least two physical variables of the technical system for at least two of the multiple data processing areas during a processing of at least one part of the input data, the at least two physical variables each being assigned to a different data processing area of the multiple data processing areas, the at least two physical variables being at least temporarily supplied to the neural network as input variables

11. A non-transitory computer-readable storage medium on which is stored commands for training an artificial neural network, which is configured to model at least one part of a technical system including multiple data processing areas, the technical system being configured to process input data, the technical system including a computing device for carrying out cryptographic methods, based on the input data, the commands, when executed by a computer, causing the computer to perform the following steps:
operating the technical system using known input data;
ascertaining at least two physical variables of the technical system during operation of the technical system, using the known input data, the at least two physical variables each being assigned to a different data processing area of the multiple data processing areas; and
training the neural network as a function of at least the known input data and/or the at least two physical variables.

12. A method, comprising:
a) carrying out at least one side channel attack on a technical system having multiple data processing areas, the technical system being configured for processing input data, the technical system being a computing device configured to carry out cryptographic methods;
b) combining side channel information of the technical system assigned to different processing areas of the multiple data processing areas;
c) training the neural network; and
d) training the neural network to combine the side channel information of the technical system assigned to the different processing areas.
